(19) United States
(12) Patent Application Publication
(10) Pub. No.: US 2021/0312461 A1
(43) Pub. Date: Oct. 7, 2021

(54) DATA SHARING METHODS, APPARATUSES, AND DEVICES

(71) Applicant: ALIPAY (HANGZHOU) INFORMATION TECHNOLOGY CO., LTD., Hangzhou (CN)

(72) Inventor: Siyuan Lou, Hangzhou (CN)

(73) Assignee: ALIPAY (HANGZHOU) INFORMATION TECHNOLOGY CO., LTD., Hangzhou (CN)

(21) Appl. No.: 17/349,517

(22) Filed: Jun. 16, 2021

(30) Foreign Application Priority Data
Jul. 31, 2020 (CN) 202010757701.5

(51) Int. Cl. G06Q 20/40; G06Q 20/38

(52) U.S. Cl. CPC G06Q 20/4016; G06Q 20/389; G06Q 20/4014

(57) ABSTRACT

Disclosed herein are methods, systems, and apparatus, including computer programs encoded on computer storage media for data sharing. One of the methods includes determining whether accumulated data corresponding to a user is stored in a first blockchain node of a blockchain network. In response to determining that the accumulated data is not stored in the first blockchain node, a data query request is broadcast to a plurality of blockchain nodes of the blockchain network other than the first blockchain node. One or more pieces of transaction link data are received from the plurality of blockchain nodes of the blockchain network. The accumulated data is retrieved based at least on the one or more pieces of transaction link data and according to a predetermined rule. It is determined whether the transaction request comprises a suspicious transaction based on retrieved accumulated data.

### CROSS-REFERENCE TO RELATED APPLICATIONS

This application claims priority to Chinese Patent Application No. 202010757701.5, filed on Jul. 31, 2020, which is hereby incorporated by reference in its entirety.

### TECHNICAL FIELD

The present specification relates to the field of blockchain technologies, and in particular, to data sharing methods, apparatuses, and devices.

### BACKGROUND

Because of cost, benefit, data sensitivity, data security, and many other considerations, enterprises are not willing to exchange and share their service data with other enterprises, and therefore, there are a large number of “data silos” or “information silos” in various industries.

At present, a scheme capable of carrying out data sharing across organizations is a common asymmetric data query way established by a third-party authority (e.g., a court) due to special reasons (e.g., needs for court execution referees), i.e., enterprises open data query services to the third-party authority, the third-party authority queries data stored by the enterprises based on the query services, and data exchange and sharing cannot be carried out between the enterprises.

Therefore, there is a need for a scheme of data exchange and sharing between enterprises.

### SUMMARY

To this end, the embodiments of the present specification provide data sharing methods, apparatuses, and devices, so that data in enterprises can be exchanged and shared across organizations to reduce the difficulty and cost of enterprise information-based construction and improve data utilization.

The embodiments of the present specification adopt the following technical solutions:

The embodiments of the present specification provide a data sharing method, including the following:

When a transaction request initiated by a user is received, it is determined whether accumulated data corresponding to the user exists in a blockchain, where the accumulated data is industry experience data used for representing whether the transaction request of the user is a suspicious transaction.

A data query request is broadcast to a blockchain node in the blockchain when it is determined that the accumulated data does not exist in the blockchain, where the data query request includes user information of the user.

Transaction link data returned by the blockchain node in response to the data query request is received, where the transaction link data is link data of transaction data corresponding to the user information in the blockchain node.

accumulated data corresponding to the user is mined based on the transaction link data.

The embodiments of the present specification also provide a data sharing apparatus, including: a determining module, configured to determine, when a transaction request initiated by a user is received, whether accumulated data corresponding to the user exists in a blockchain, where the accumulated data is industry experience data used for representing whether the transaction request of the user is a suspicious transaction; a broadcasting module, configured to broadcast a data query request to a blockchain node in the blockchain when the determining module determines that the accumulated data does not exist in the blockchain, where the data query request includes user information of the user; a receiving module, configured to receive transaction link data returned by the blockchain node in response to the data query request, where the transaction link data is link data of transaction data corresponding to the user information in the blockchain node; and a mining module, configured to mine the accumulated data corresponding to the user based on the transaction link data.

The embodiments of the present specification also provide an electronic device for data sharing, including: at least one processor; and a memory communicatively coupled to the at least one processor, where the memory stores instructions executable by the at least one processor, where the instructions are executed by the at least one processor such that the at least one processor is able to: determine, when receiving a transaction request initiated by a user, whether accumulated data corresponding to the user exists in a blockchain, where the accumulated data is industry experience data used for representing whether the transaction request of the user is a suspicious transaction; broadcast a data query request to a blockchain node in the blockchain when determining that the accumulated data does not exist in the blockchain, where the data query request includes user information of the user; receive transaction link data returned by the blockchain node in response to the data query request, where the transaction link data is link data of transaction data corresponding to the user information in the blockchain node; and mine the accumulated data corresponding to the user based on the transaction link data.

The previously described at least one technical solution adopted in the embodiments of the present specification can achieve the following beneficial effects:

Organization participants who need to assume predetermined obligations and are willing to share data form a data sharing consortium, industry accumulated data is formed by using shared fragment data. As such, data silos are relieved, an industry experience shareable way is provided, the operation cost of the organization participants assuming the predetermined obligations can be greatly reduced, the compliance service risk of the organization participants can be reduced, and the supervision efficiency of a third-party authority can be improved.

### BRIEF DESCRIPTION OF DRAWINGS

In order to more clearly illustrate the embodiments of the present specification or the technical solutions in the existing technology, the drawings used in the description of the embodiments or the existing technology will be briefly described below. Clearly, the drawings in the following description are only some of the embodiments described in the present specification, and those of ordinary skill in the art can obtain other drawings based on these drawings without involving any creative effort.

FIG. 1 is a schematic structural diagram illustrating an example of a data sharing application scheme, according to one or more embodiments of the present specification;

FIG. 2 is a flowchart illustrating an example of a data sharing method, according to one or more embodiments of the present specification;

FIG. 3 is a schematic diagram illustrating an example of a smart contract in a data sharing method, according to one or more embodiments of the present specification;

FIG. 4 is a schematic diagram illustrating an example of a data structure of accumulated data in a data sharing method, according to one or more embodiments of the present specification;

FIG. 5 is a schematic structural diagram illustrating an example of block data in a data sharing method, according to one or more embodiments of the present specification;

FIG. 6 is a schematic structural diagram illustrating an example of a data storage layer in a data sharing method, according to one or more embodiments of the present specification;

FIG. 7 is a schematic logic diagram illustrating an example of an incentive mechanism in a data sharing method, according to one or more embodiments of the present specification;

FIG. 8 is a schematic logic diagram illustrating an example of penalty by a supervision node in a data sharing method, according to one or more embodiments of the present specification;

FIG. 9 is a schematic architecture diagram illustrating an example of a blockchain for data sharing in a data sharing method, according to one or more embodiments of the present specification;

FIG. 10 is a schematic structural diagram illustrating an example of a service application layer in a blockchain structure in a data sharing method, according to one or more embodiments of the present specification; and

FIG. 11 is a schematic structural diagram illustrating an example of a data sharing apparatus, according to one or more embodiments of the present specification.

### DESCRIPTION OF EMBODIMENTS

To make those skilled in the art better understand the technical solutions in the present specification, the technical solutions in the embodiments of the present application will be clearly and comprehensively described below with reference to the accompanying drawings in the embodiments of the present application. Clearly, the described embodiments are only some of the embodiments of the present application and not all embodiments. All other embodiments obtained by those of ordinary skill in the art based on the embodiments of the present specification without involving any creative effort should fall within the scope of protection of the present application.

At present, for the practical purpose of evading supervision, suspects who conduct illegal transactions often consciously design transaction links to span multiple financial organizations, multiple links, and multiple subjects. For example, funds of financial transactions span multiple fund circulation channels, such as banks, third-party payment platforms, e-commerce platforms, and offline transactions, so that the subjects in each transaction link only have a part of slice data, resulting in that the suspicious part of the transaction cannot be quickly found only by transaction data of each organization, the link of the entire transaction data cannot be discovered clearly, the suspicious transaction cannot be identified efficiently and accurately, and the funds of the illegal transactions will be successfully transferred when the organizations find clues. Therefore, a large amount of illegal transaction behaviors cannot be effectively blocked due to high concealment degree and complex link.

The situation is known in the industry as a “data silo” phenomenon.

The inventors find, through deep analysis, that the main reasons causing the “data silo” phenomenon are as follows:

(1) The technical implementation of cross-organization data exchange and sharing is difficult.

Compared with common Internet data (e.g., login, browsing, and clicking), enterprises are different in terms of storage, processing quality, and interfaces of user transaction data, unified output is difficult to achieve for data of all the enterprises, and a lot of difficulties are added to data exchange and sharing.

(2) The motivation for data exchange is insufficient.

For example, transaction data is often highly confidential data of enterprises and users (e.g. identity numbers, bank card numbers, transaction records, transaction objects, and consignee's address). In practice, enterprises cannot fully trust each other, and the input-output ratio of data information construction is also a concern. Therefore, the motivation of data exchange and sharing of enterprises is significantly insufficient, so improving the willingness of enterprises is even more difficult than overcoming the technical difficulty.

(3) “Cold start” is costly.

If new organizations are established, it is necessary to not only accumulate from scratch, but also need to accumulate data and construction experience for a long period of time due to own ability factors.

That is, many enterprises (or organizations) either have no technical ability to identify suspicious money laundering risk users, or are not willing to invest manpower and material resources for information construction in consideration of cost and profit, or are not willing to exchange and share data with other enterprises. Consequently, the enterprises cannot accumulate and share their own data and accumulated industry experience. Therefore, the enterprises carry out duplicate construction, the construction cost is high, and the data utilization rate is low. Moreover, enterprises face more supervision pressure, and the risk of penalty is also increasing.

For example, in the financial industry, supervision requirements for know your customer (KYC), suspicious transaction report (STR), etc. are increasing. More enterprises are penalized by supervision due to insufficient information construction, failure to identify illegal transactions, and other reasons. As shown from data disclosed by the supervision departments, the total penalty amount reaches RMB 0.174 billion in the first quarter of 2020, where there are 16 penalties with the amount of over one million, 100% of the penalties relate to “not fulfilling the obligations of customer identity recognition based on regulations”, and 56% of the penalties relate to “trading with customers with unknown identities.”

Therefore, because financial transactions are complex and suspects deliberately design transaction fund links to span organizations, subjects, multiple links, etc., if relying solely on data accumulated by a certain organization, suspicious transactions will not be found quickly, so there are great hysteresis effect and omission in the identification of illegal transactions.

To this end, through technical analysis, the inventors explore a scheme capable of performing data exchange and sharing across organizations. Cross-organization data exchange and sharing between the organizations in industries can be realized by constructing a sharing consortium and establishing an industry experience accumulation system, and enterprises can perform deep customer identification in a low-cost way, so as to save huge investment cost of the enterprises, improve the ability of the enterprises to satisfy supervision requirements, and contribute to the whole society to fight against illegal transactions.

Based on this, the embodiments of the present specification provide a new data sharing scheme.

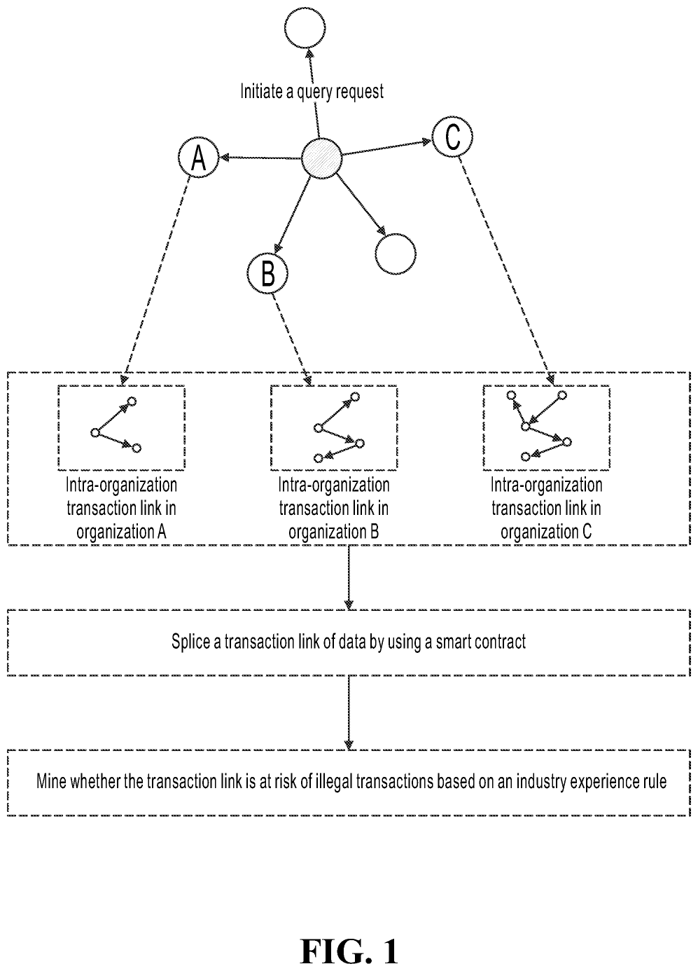

FIG. 1 is a schematic structural diagram illustrating an example of a data sharing application scheme, according to one or more embodiments of the present specification.

As shown in the figure, an organization that receives a transaction request initiated by a user firstly queries whether the user has corresponding accumulated data in a current blockchain, where the accumulated data is industry experience data used for representing whether the transaction request of the user is a suspicious transaction, and the industry experience data is data that is obtained by accumulating experience of the organization in the industry and shared in the blockchain. When the accumulated data cannot be used to determine whether the transaction request of the user belongs to a suspicious transaction, the organization will broadcast a data query request to other members within a sharing consortium (for simplicity of illustration, only organization members A, B, and C are marked in the figure), and each member node receiving the query request can respond to the query request to share existing data related to the user in the present node, where the existing data can be link data related to transactions of the user in the present organization, such as intra-organization transaction link data of the user in organization A, intra-organization transaction link data in organization B, and intra-organization transaction link data in organization C. Then, data processing (e.g., cleaning and processing) is performed on fragment data shared by all organizations by using a smart contract to obtain a transaction link related to the user. Finally, based on an industry experience rule, e.g., a predetermined experience rule which can be a smart contract formed by industry experience, it is mined whether suspicious risks of illegal transactions exist for the user in the query request.

Based on the data sharing scheme provided by the embodiments of the present specification, the adopted blockchain can be a consortium blockchain, where each blockchain node in the consortium blockchain can include organization participants who need to assume predetermined obligations (e.g., obligations of fighting illegal transactions and obligations of supervision) and are willing to form a data sharing consortium, and each newly added node needs to be verified and audited so as to ensure that each node has obligations and is willing to participate in data sharing.

The technical solutions provided by the embodiments of the present application are described in detail below with reference to the accompanying drawings.

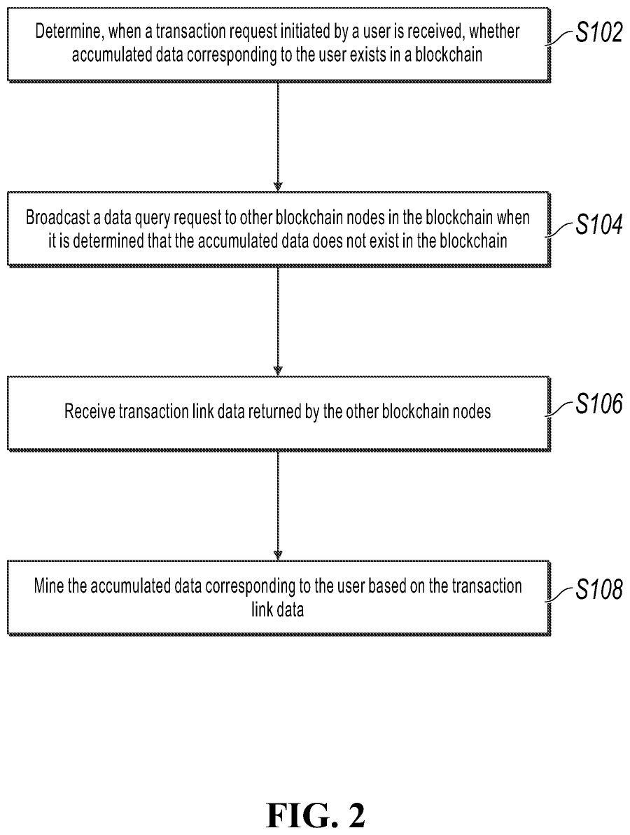

As shown in FIG. 2, the embodiments of the present specification provide an example of a data sharing method, which can be applied to a first blockchain node and can include the following steps:

S102. When a transaction request initiated by a user is received, determine whether accumulated data corresponding to the user exists in a blockchain.

The accumulated data is industry experience data used for representing whether the transaction request of the user is a suspicious transaction.

In specific implementations, a first blockchain node is the first node when a user conducts a transaction. For example, when the user performs a transfer operation at a bank, the first blockchain node can be a transferor bank, and the first blockchain node can firstly determine whether a transaction request of the user may be a suspicious transaction based on accumulated data existing in a blockchain.

If a suspicious transaction or a non-suspicious transaction can be determined based on the accumulated data, the transaction request of the user can be correspondingly processed. For example, if the transaction is suspicious, the transaction request of the user can be intercepted, retained, recorded, tracked, reported, etc. if the transaction is not suspicious, the transaction of the user is directly released, that is, the transaction request of the user is completed.

If no accumulated data is used for determining whether the transaction of the user belongs to a suspicious transaction, i.e., there's no accumulated data in the current blockchain that can be used for determining whether the transaction of the user belongs to a suspicious transaction, and the transaction data of the user in other organizations need to be combined for further determination. In this case, the first blockchain node can generate a data query request based on the transaction request of the user, to request data from other blockchain nodes (i.e., other organizations) in the blockchain.

It is worthwhile to note that the industry experience data can be industry experience data accumulated in fighting against illegal transactions, and can be determined based on practical application scenarios. For example, the industry experience data can be industry rules and experience for fighting against money laundering in the banking industry.

In some implementations, the first blockchain node can determine whether the transaction request of the user is a suspicious transaction based on the accumulated data in the blockchain.

In some implementations, the first blockchain node can determine whether the transaction request of the user is a suspicious transaction based on a smart contract, where the smart contract can be integrated with corresponding contract rules for determining that the transaction request of the user is at risk of a suspicious transaction.

S104. Broadcast a data query request to other blockchain nodes in the blockchain when it is determined that the accumulated data does not exist in the blockchain, where the data query request includes user information of the user.

In specific implementations, the data query request can be generated based on a transaction request of a user. For example, the data query request can include user information of the user, as well as transaction objects, transaction links, etc.

Shared data of each organization participant can be spliced through the user information. Therefore, the user information can include an identifier of the user in various organizations, such as an identity card number, a business license number, and an account.

S106. Receive transaction link data returned by the other blockchain nodes, where the transaction link data is link data of transaction data corresponding to the user information in the other blockchain nodes.

In specific implementations, each blockchain node in the blockchain, i.e., the first blockchain node and other blockchain nodes, are organization participants who assume predetermined obligations (e.g., obligations of fighting against illegal transactions) and are willing to form a data sharing consortium.

In some implementations, each newly added node needs to be verified, audited, etc. to ensure that each node added can assume predetermined obligations and is willing to participate in data sharing.

S108. Mine the accumulated data corresponding to the user based on an industry experience rule.

In specific implementations, the industry experience rule can be a rule formed based on the experience of fighting against illegal transactions in the industry, fragment data shared by various organizations can be rapidly processed through the industry rule so as to identify the risk degree that a transaction of a user may be a suspicious transaction, and accumulated data corresponding to the user is formed and accumulated in a blockchain.

Through the previous steps S102 to S108, based on the industrial characteristics of the application field and the expert experience of suspicious transactions, organization participants who are willing to assume obligations to fight against illegal transactions and are willing to share data form a data sharing consortium, and then based on a consortium blockchain, a data sharing and experience sharing system is designed, so that data in the system is more targeted, and the usage rate is higher, thereby reducing the cost and improving the efficiency of identifying suspicious transactions by the whole industry, and greatly reducing the financial cost and time cost of accumulating industry experience for newly-established organization participants.

In some implementations, since the accumulated data is industry experience data obtained by mining segment data shared by various organizations, i.e., the accumulated data is obtained by re-performing risk mining after splicing shared data fragments, the accumulated data already includes experience data such as strategies, rules, and models accumulated by various organizations.

In specific implementations, accumulated data can be combined with a smart contract, i.e., industry experience rules for determining suspicious transactions are integrated in the smart contract, so that computer programmed rules can be automatically used to quickly determine whether a transaction request of a user is a suspicious transaction.

In some implementations, since an ETH-implemented smart contract already has a Turing-complete programming language function and can actually support the definition of any complex contract rules in practice, industry experience data (e.g., experience and rules) in the data sharing consortium can be described as the contract rules of the smart contract with help of the ETH-implemented smart contract.

By adopting the smart contract, the industry experience data can be conveniently accumulated, and the possibility that the transaction request of the user belongs to a suspicious transaction can be quickly determined based on the smart contract of the blockchain when the first blockchain node receives the transaction request of the user.

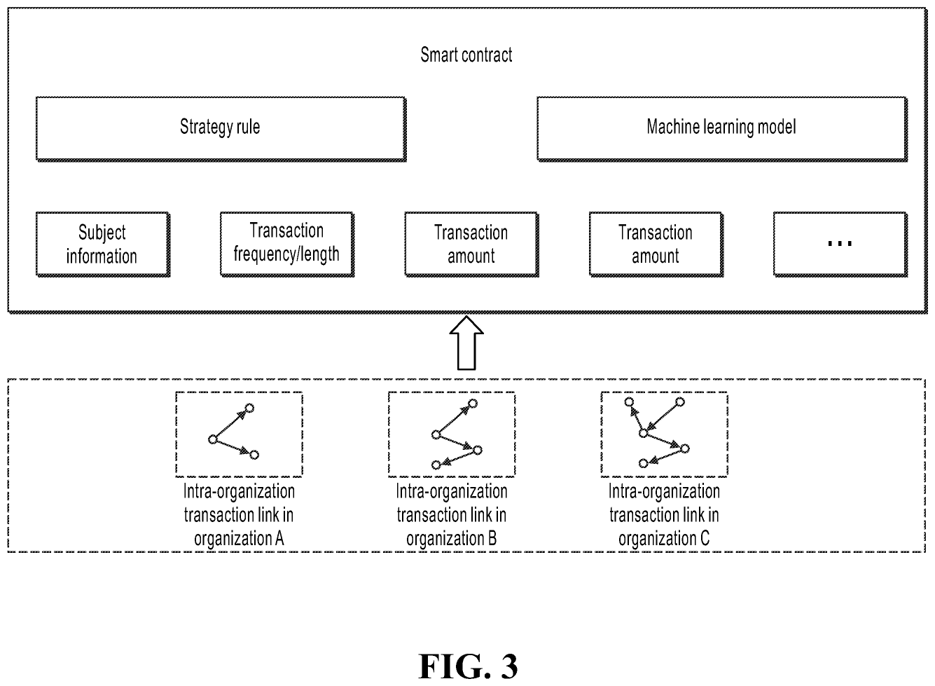

In some implementations, an overall architecture diagram of an example of a smart contract can be shown in FIG. 3.

As shown in the figure, in the structure of a smart contract, industry experience data used for describing corresponding contract rules can include strategy rules of the industry, a machine learning model, and intra-organization transaction link data shared by various organizations, such as subject information in transaction data, transaction frequency or length (duration), transaction opponent, and transaction amount, e.g., intra-organization transaction links in organization A, intra-organization transaction links in organization B, and intra-organization transaction links in organization C.

The smart contract is formed by describing the industry data as corresponding contract rules, so that the smart contract aims to embody the sharing and accumulation of the industry data (e.g., experience knowledge) to obtain data shared by various organization participants, the smart contract can be used for mining accumulated data from fragment data shared by various organization participants, corresponding contract rules are formed, and the transaction risk can be quickly determined.

It is worthwhile to note that the smart contract can be described with reference to the ETH smart contract and specific application scenarios, which is not specifically limited here.

In some implementations, the user information of the user can be used as a data identifier in the accumulated data, and then the accumulated data is stored in the blockchain by using the data identifier, so that the data can be conveniently and quickly queried based on the user information.

In some implementations, the user information is involved in user data constructed by each organization, so the data identifier of the accumulated data can be the user information of the user, or the data identifier of the accumulated data can be included in the user data when the user data is constructed in the data construction of each organization, so as to facilitate the accumulation processing of the fragment data shared by each organization in the blockchain.

In specific implementations, when each organization constructs user data, an identity number of a user is usually involved, and the identity number usually uniquely corresponds to a natural person and an enterprise in a real life scenario, so the user information in the accumulated data can adopt the identity number of the user. For example, the identity number can include an ID number, a passport identity number, a social security number, a business license number, an organization code, etc. based on the user identity.

However, in reality, various organizations are under various consideration, and the identity number is often not used as the data processing granularity in the data construction.

For example, for organizations participating in data sharing, a current account number system is often designed such that an identity number (i.e., a natural person or an enterprise) can apply for opening multiple intra-organization accounts. For example, in the banking industry, a natural person can use the same identity card to open multiple bank accounts in the same bank, such as opening multiple bank cards, so it is difficult to use the identity number as the data processing granularity.

For example, in the data construction of risk strategies, rules, models, etc., account numbers, transaction dimensions, etc. are used as the processing granularity in the organizations. At present, the reason is that it is difficult to ensure high precision at the natural person granularity by depending only on data of an enterprise, and the enterprise is not willing to process in the identity number granularity in consideration of own service goals.

For example, suspects engaged in illegal transactions often obtain batches of identity numbers from an upstream illegitimate industry and register numerous transaction accounts with these identity numbers so that the illegal transaction can be quickly switched to a new account (or a new account can be quickly registered) even if one account is blocked in the illegal transaction.

Therefore, when the fragment data shared by each organization is subjected to data retention, if the data retention is not unified at the same data processing granularity, the data volume is very high and complex, and the unification and storage of data exchange and sharing are not facilitated.

In specific implementations, since an identity number behind an account is unchanged, the data retention in the data sharing consortium can be unified at the data processing granularity of the identity number, so that whether suspicious transactions exist in the newly registered account related to the identity number can be efficiently identified, and it is also conducive to the large-scale convergence of the data volume of the data retention.

In the data sharing scheme provided by the embodiments of the present specification, an identity number can be used as a data identifier of accumulated data, so that the accumulated data can be implemented at the granularity of the “identity number.”

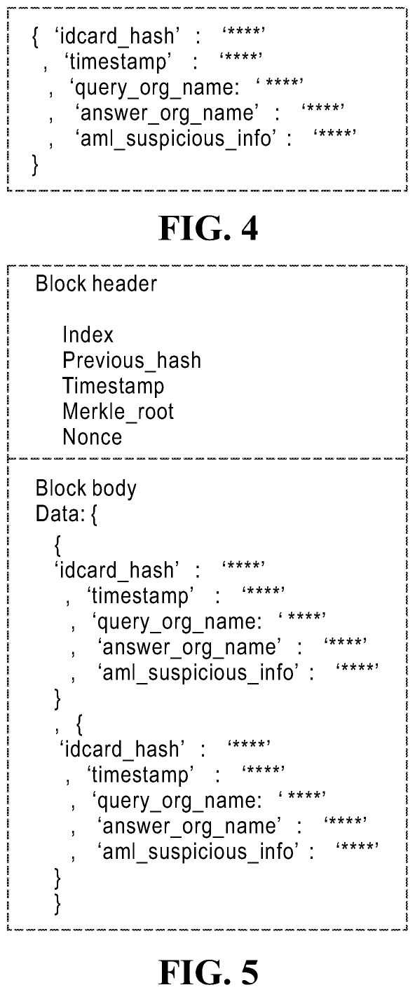

In some implementations, after the processing of shared data is unified to the identity number, the data structure of the accumulated data eventually accumulated onto the blockchain can adopt an example of a data structure shown in FIG. 4.

As shown in the figure, idcard_hash can correspond to a HASH value of an identity number (indicated by an asterisk in the figure), thereby ensuring the privacy and security of data by encrypting the identity number. “timestamp” can be a timestamp, such as a UNIXTIME timestamp for indicating a generation time of the data record. “query_org_name” can be the name of an organization that initiates the query. “answer_org_name” can be the name of an organization responding to the information. Therefore, there can be multiple “answer_org_name” that can be stored in a form of list. “aml_suspicious_info” can be used as data retention information of a suspicious transaction, is an open data item in the embodiments of the present specification, can store risk records, penalty actions, etc. performed by various organizations on the identity number, and can also be a conclusion that various organizations clearly identified transactions as suspicious transactions, etc.

Therefore, after the data shared by each organization is obtained, the granularity of data processing can be unified to the same granularity, such as an identity number, and then accumulated data is formed from the granularity-unified data, so that the accumulated data is stored in a blockchain, and the accumulated data can be conveniently queried from the blockchain.

It is worthwhile to note that the data structure can be designed based on data of an actual application scenario, and is not specifically limited here.

In some implementations, the accumulated data can be formed into blocks and recorded to the blockchain.

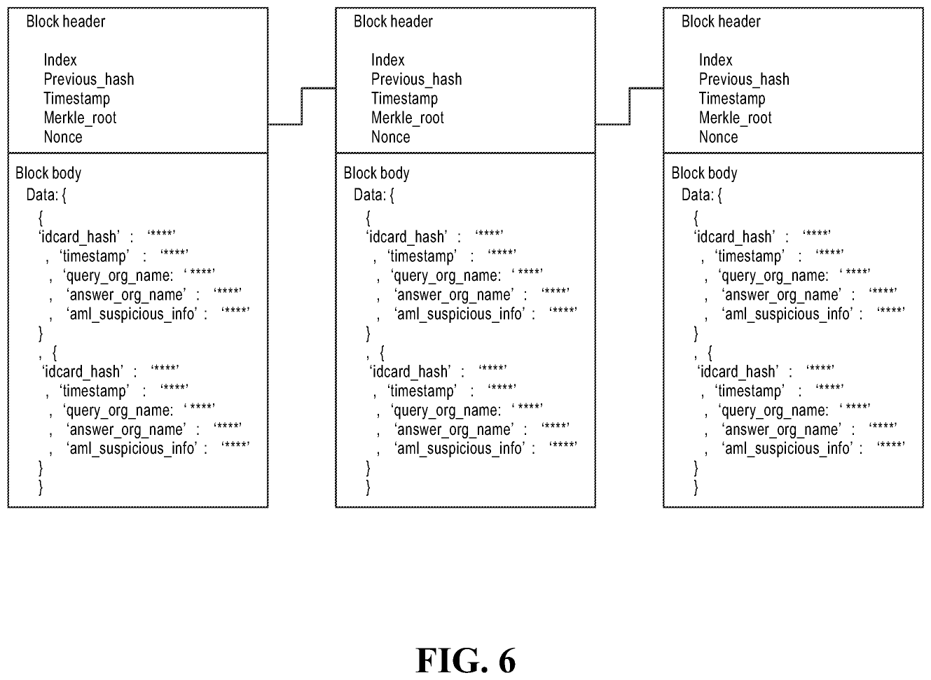

In specific implementations, an example of block data shown in FIG. 5 can be adopted and an example of a blockchain shown in FIG. 6 can be formed.

As shown in FIG. 5, the block data can include a block header and a block body.

The block header is used for storing various identifiers identifying the block data, and the block body is used for storing the data.

For example, in the block header, Index can be used to identify block data number, Previous_hash can be connected to HASH of the previous block (i.e., Merkle_root), Timestamp can be a timestamp for identifying a generation time of the block, and Nonce can be used for identifying data state changes, such as credits for incentives. The block body can adopt the previously described data structure (refer to FIG. 4).

As shown in FIG. 6, each of the previously described blocks can be linked to form a blockchain from block to chain, i.e., to form a data storage layer in the blockchain.

In specific implementations, Previous_hash of the next block can be connected to Merkle_root of the previous block to form the data storage layer in the blockchain.

In some implementations, since multiple cross-domain and multi-subject participation application technologies cannot be effectively utilized in reality, not because it's difficult to implement the technologies, but more because a set of incentive and feedback mechanisms for users are not designed in advance, each participant cannot be attracted to be willing to continue to use. Consequently, a technology platform is created without practical value. This is also one of the reasons for a large number of data silos in current industries.

Therefore, in the data sharing scheme provided by the embodiments of the present specification, a contribution value of an organization is introduced.

In specific implementations, a corresponding data structure can be arranged in the accumulated data, the contribution value of each organization can be reflected through the value of the data, where the contribution value can be obtained based on the contributions of each organization to a sharing consortium (i.e., a blockchain), to encourage all parties to participate in data sharing, the sharing can be ensured to operate continuously, and the practical social application value is achieved.

In specific implementations, the contribution value can be embodied in the form of “credit coin”. For example, current_coin can be added to the previously described data structure (refer to FIG. 4) for recording the current credit coin.

In some implementations, the contribution value can be used as “equities” of each organization participant in a sharing platform, and the use behavior of each organization participant is constrained and regulated based on the equities, so that the willingness of each organization participant to share data is improved.

In specific implementations, the contribution value can be used as equities to formulate a sharing operation mechanism, and corresponding incentive mechanisms can be specifically designed for two types of different blockchain nodes.

In specific implementations, corresponding credits logics can be designed for credit incentives of various blockchain nodes of different types.

For example, for a blockchain node querying data, when being read, a determination can be made to verify whether an organization initiating the query still has credits available, and if not, an error is reported.

Therefore, for a node querying data (e.g., organization A), operating mechanism logic for the equities in reading can be as follows: if (credit coin of organization A>predetermined credit value) {query(idcard_hash)} else{return “insufficient credit coin” }.

For example, for a blockchain node that writes data, a credit that contributes to the data is added to a block corresponding to the organization upon writing.

Therefore, for a node writing data (e.g., organization A), operating mechanism logic for the equities in writing can be as follows: if writing is valid, then credit coin (organization A)=credit coin (organization A)+predetermined increment value.

It is worthwhile to note that a predetermined credit value in the previously described reading logic can be set based on actual application, for example, to 0. Also, the predetermined increment value in the writing logic can be set based on actual application, for example, to N, 2*N, etc.

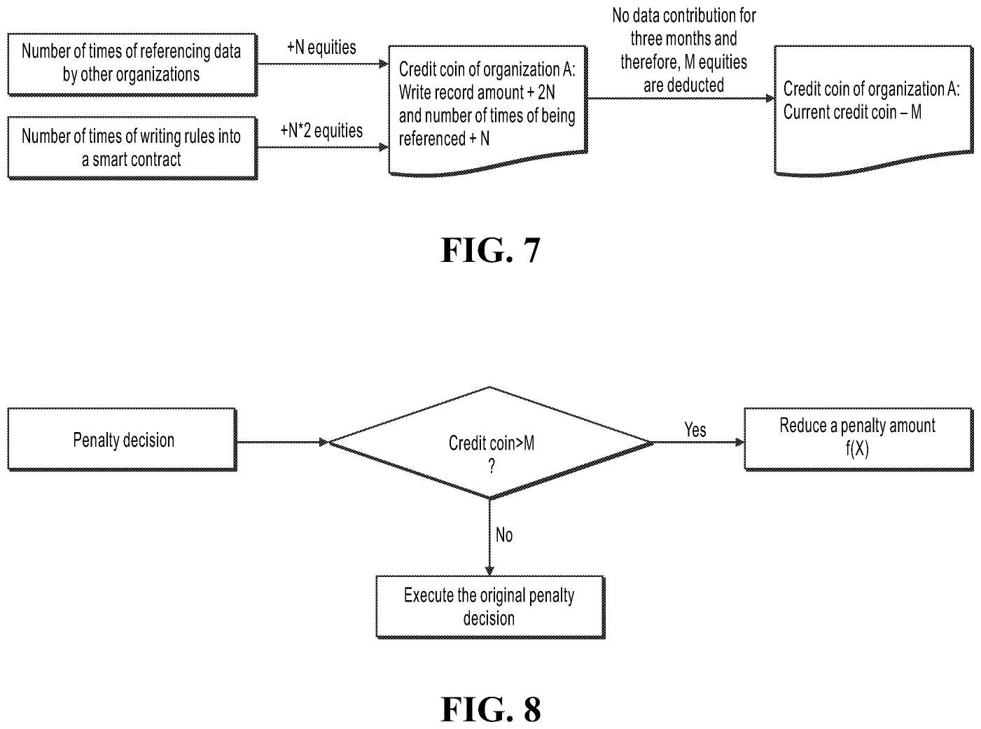

In some implementations, the incentive logic can adopt a schematic diagram shown in FIG. 7 for credit coin of each organization participant.

As shown in the figure, credit coin of organization A can include credit coin obtained upon writing and credit coin obtained upon reading data (i.e., data shared by organization A is referenced by other organizations). For example, upon writing, the credit coin (i.e., equities) can be increased by 2*N (i.e., 2N) accordingly based on the number N of times of writing rules into the smart contract. For example, the credit coin can be increased by N accordingly based on the number N of data referenced by other organizations.

In addition, if there is no contribution for a long time, corresponding credit coin can be deducted to better stimulate the enthusiasm of the contribution data of each organization. For example, if organization A has no data contribution for three months, credit coin of organization A can be deducted by M, i.e., credit coin of organization A=current credit coin−M.

Therefore, by introducing an incentive mechanism and corresponding incentives for different contributions of nodes, the contribution of organization participants to smart contract rules is more prominent, the industry experience and knowledge accumulation and sharing of organization participants are better embodied, and the more valuable sharing in the sharing consortium is embodied.

In some implementations, the supervision pressure faced by organization participants is mainly due to the compliance supervision of a third-party authority (i.e., a supervision entity). Therefore, the supervision entity can be incorporated into the sharing consortium as a blockchain node in the sharing consortium, so that the supervision entity can see the industry contributions of the organization participants, and the industry contributions can be used as reference information during supervision to form certain policy space for the organization participants in supervision to further stimulate the organization participants.

In specific implementations, the supervision logic of the supervision entity can adopt schematic logic shown in FIG. 8.

As shown in the figure, when the supervision entity makes a penalty decision, the supervision entity can determine whether a penalized organization participant in the blockchain satisfies predetermined conditions based on the contribution of a penalized organization to the sharing consortium, where the predetermined conditions can be used for representing whether the organization actively participates in the sharing consortium, e.g., whether the current blockchain credit coin of the organization is larger than a predetermined threshold (the predetermined threshold is N in the figure). The predetermined threshold is a threshold representing that the organization actively participates in sharing. If so, the penalty amount can be reduced, and the reduced penalty amount can be set to an amount obtained based on function f(X), where X is a value of the current credit coin of the organization, function f(X) represents a function for adjusting the penalty amount based on the current credit coin of the organization, and function f(X) can be set based on an actual application scenario. For example, f(X) is a linear function and is not specifically limited. If not, the original penalty decision is implemented.

Therefore, through the incentive mechanism, the supervision entity and the organization participants can obtain benefits, all parties can be better stimulated to actively use the sharing platform, and the use value of the applied platform can be increased.

For example, for a blockchain node of an organization participant, benefits can be embodied as follows:

(1) The accumulated data in the blockchain is queried, for example, the accumulated data is data retention information of a user risk, the defect of self data construction can be quickly compensated, the input cost of data construction and the internal operation cost can be reduced, the compliance inspection such as know your customer (KYC) and suspicious transaction report (STR) can be quickly and accurately carried out, and the compliance risk can be reduced.

(2) By writing data into the blockchain, the written data are referenced by other organizations, etc., the credit coin in the sharing consortium can be accumulated, and by the accumulated credit coin, the supervision entity can be enabled to sense the contribution of the organization participants to the industry, so that the penalty risk can be reduced, or the penalty level can be reduced, the operation risk can be reduced, and the operation cost can be saved.

For example, for a blockchain node of a supervision entity, benefits can be embodied as follows:

(1) The attention degree of each organization participant to the work of fighting against illegal transactions is improved, the contribution degree of each organization participant can be quantified, and the contribution degree can be used as reference information when compliance inspection and penalty are carried out.

(2) The sanction control work can be more efficiently deployed, and an identity number of a person needing to be sanctioned is directly written into a blockchain, so that each organization participant can get to know in a timely manner, and the hysteresis effect and the omission risk of the list management work of each organization participant are reduced.

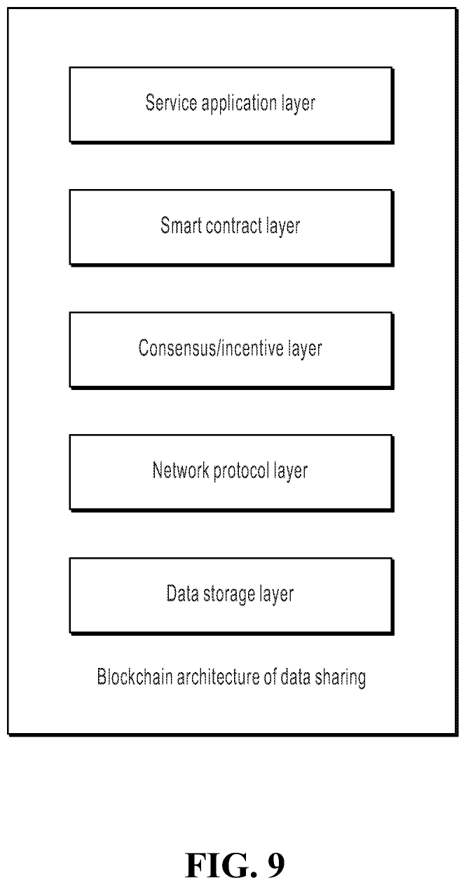

In some implementations, the blockchain in the sharing consortium can be hierarchically designed, and the blockchain architecture of data sharing can adopt a schematic diagram shown in FIG. 9.

As shown in the figure, the blockchain architecture can include a data storage layer, a network protocol layer, a consensus/incentive layer, a smart contract layer, and a service application layer, and each architecture layer in the blockchain can be customized for the industry characteristics of fighting against illegal transactions.

In specific implementations, the data structure of the previously described implementations (refer to FIG. 4) can be used to apply fragment data shared by each organization into accumulated data, and blocks of the accumulated data (refer to FIG. 5) are linked to the data storage layer (refer to FIG. 6) in the blockchain. Details are omitted here for simplicity.

In specific implementations, in the network protocol layer, the blockchain can use a peer-to-peer (P2P) type distributed network, which can include pure distributed, hybrid, structured P2P networks, etc.

In some implementations, a structured P2P network based on a distributed hash table (DHT) can be used in the network protocol layer, the core idea of which is to establish indexes of resource data and node data respectively, so as to efficiently locate which part of data is stored on which block node. The principle is consistent with a Kademlia algorithm used by the Ethereum, i.e., a binary prefix tree is established based on a unique ID index value of each node, so that data can be quickly indexed. Here, the ID index value can be set to the identity number in the previously described embodiments. Details are omitted here for simplicity.

A transmission control protocol and Internet protocol (TCP/IP) network protocol can be used as a communication protocol. Details are omitted here for simplicity.

In some implementations, the network protocol layer can further include functions related to network verification for nodes, network verification can be performed when a node mechanism accesses a network, illegal network nodes are removed from the sharing consortium, and illegal nodes are prevented from entering subsequent services.

In specific implementations, in the consensus/incentive layer design, consensus content such as verification, auditing, and authorization can be set for newly added nodes, and an incentive mechanism for blockchain nodes can be set.

For the consensus for nodes, references can be made to the existing blockchain consensus, and currently mainstream consensus mechanisms in the industry include proof-of-work (PoW), proof-of-stake (PoS), delegated proof-of-stake (DPoS), Byzantine fault tolerance (BFT), practical Byzantine fault tolerance (PBFT), RAFT, etc.

The data sharing scheme provided by the embodiments of the present specification adopts a consortium blockchain, and organization participants can be organizations which need to assume predetermined obligations, such as financial organizations or third-party payment organizations that fight against illegal transaction obligations, so that the probability of subjective intentional fraud of the organization participants is very low.

Therefore, a more concise delegated proof-of-stake (DPoS) consensus mechanism can be used to effectively reduce the quantity of members of the consortium blockchain, so that the quantity of members of delegated nodes can be further reduced, for example, to 11.

With respect to the incentive mechanism, the contribution value (i.e., credit coin) incentive mechanism in the previously described embodiments can be adopted. Details are omitted here for simplicity.

In specific implementations, the smart contract in the previously described implementations (refer to FIG. 3) can be adopted, and accumulation and sharing of industry experience knowledge can be embodied through a smart contract layer. Details are omitted here for simplicity.

In specific implementations, in the service application layer design, organization participants and third-party authorities (e.g., supervision entities) can access the blockchain of the sharing consortium through the service application layer.

For example, an organization participant can submit a join application, authentication, etc. in the service application layer, and a supervision entity can view the contribution value of each organization, impose penalties, assist in determining the degree of responsibility for obligations of each organization, etc., through the service application layer.

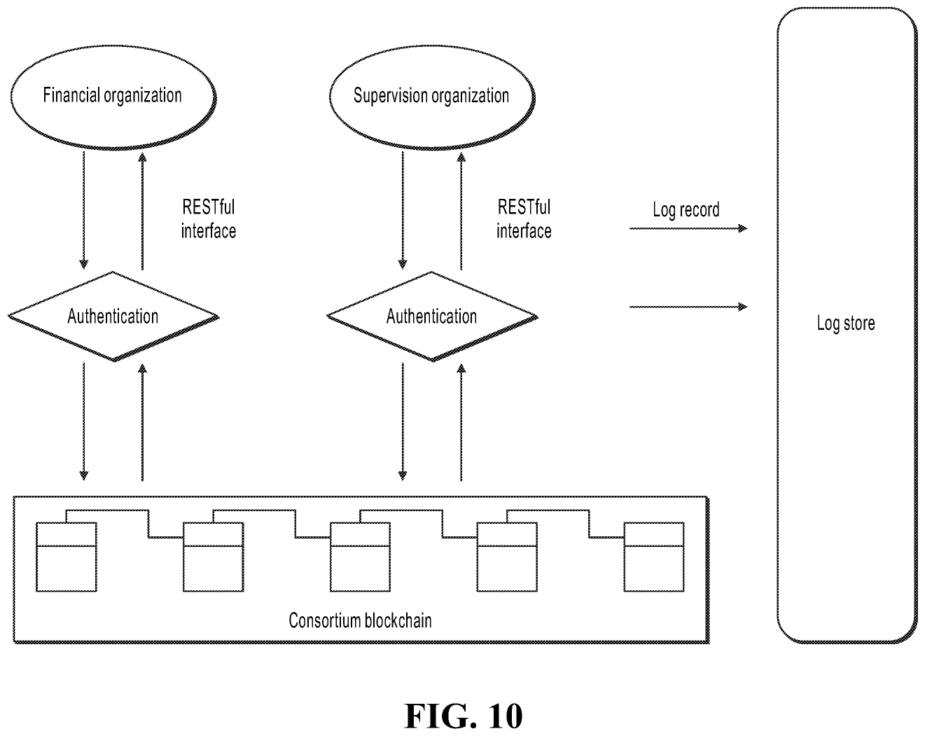

In some implementations, the system architecture shown in FIG. 10 can be adopted. A RESTful interface is provided in the service application layer. Each blockchain node, such as an organization participant (e.g., financial organization) and a third-party authority (e.g., supervision organization), performs authentication, accesses log records in a log store, and records to or retrieves from the consortium through the RESTful interface.

RESTful is a design style and development mode of a network application program. Based on hyper text transport protocol (HTTP), extensible markup language (XML) format definition or JavaScript object notation (JSON) format definition can be used. RESTful can be applied to a scenario where a mobile Internet manufacturer serves as a service enabling interface, the function that a third-party OTT invokes mobile network resources is realized, the action types are new addition, change, and deletion of the invoked resources, an organization participant does not need to change an existing data interface of the organization participant, and the organization can conveniently enter a sharing consortium platform.

By adopting the blockchain architecture in the previously described embodiments, on the basis of the blockchain technology in the industry and in combination with the characteristics of compliant services in the industry, architecture adjustment and personalized customization are carried out, so that a local sharing system can be established between some organizations, multiple local platforms can be combined into a larger sharing platform, a data sharing consortium blockchain can be constructed in different ranges, and good expansibility of the data sharing platform can be ensured. After implementation, compliance operation costs such as know your customer (KYC) and suspicious transaction report (STR) of organization participants can be greatly reduced, compliance service risks and penalty risks can be reduced, and the efficiency of supervision organizations in fighting against illegal transactions (e.g., anti-money laundering) can be improved.

Based on the same inventive concept, the embodiments of the present specification also provide apparatuses, electronic devices, and non-volatile computer storage medium for data sharing.

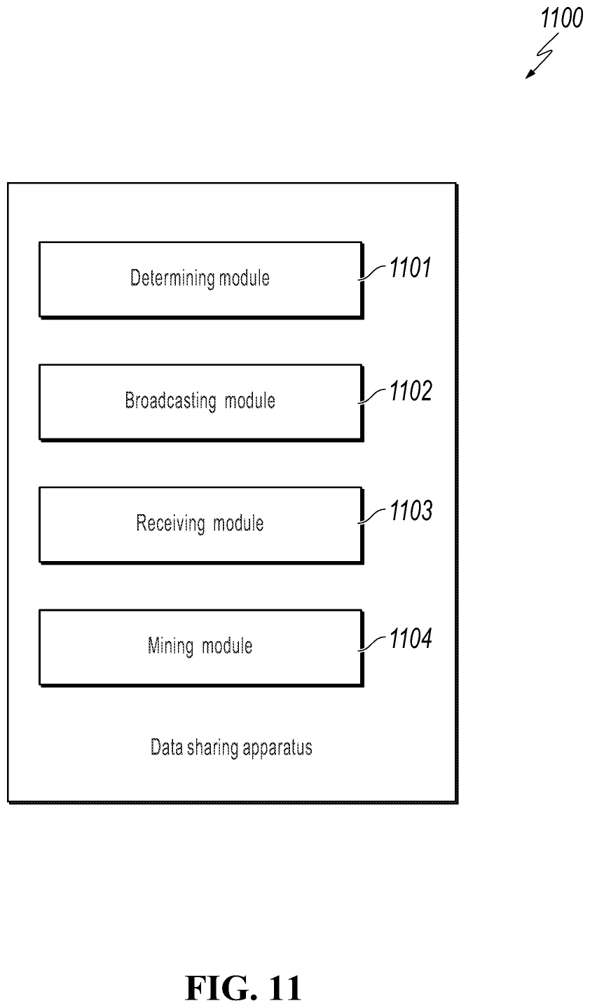

FIG. 11 is a schematic structural diagram illustrating an example of a data sharing apparatus, according to one or more embodiments of the present specification.

As shown in FIG. 11, the data sharing apparatus 1100 can include: a determining module 1101, configured to determine, when a transaction request initiated by a user is received, whether accumulated data corresponding to the user exists in a blockchain, where the accumulated data is industry experience data used for representing whether the transaction request of the user is a suspicious transaction; a broadcasting module 1102, configured to broadcast a data query request to a blockchain node in the blockchain when the determining module 1101 determines that the accumulated data does not exist in the blockchain, where the data query request includes user information of the user; a receiving module 1103, configured to receive transaction link data returned by the blockchain node in response to the data query request, where the transaction link data is link data of transaction data corresponding to the user information in the blockchain node; and a mining module 1104, configured to mine the accumulated data corresponding to the user based on the transaction link data.

Optionally, the determining whether accumulated data corresponding to the user exists in a blockchain includes: determining whether the accumulated data corresponding to the user exists in the blockchain by using a first smart contract.

Optionally, the data sharing apparatus 1100 can further include: a verification module, configured to perform identity verification on a blockchain node newly added to the blockchain.

Optionally, the mining the accumulated data corresponding to the user based on the transaction link data includes: mining the accumulated data corresponding to the user based on the transaction link data by using a second smart contract.

Optionally, the user information of the user includes an identity number of the user; and the mining the accumulated data corresponding to the user based on the transaction link data includes: obtaining the identity number from the transaction link data; and mining the accumulated data corresponding to the user from the transaction link data by taking the identity number as data processing granularity.

Optionally, the data sharing apparatus 1100 can further include: a data generation module, configured to form block data from the accumulated data, where the block data includes a block header for storing an identifier for identifying the block data, and a block body for storing the accumulated data; and a blockchain recording module, configured to record the block data.

Optionally, the data sharing apparatus 1100 can further include: a contribution identifier module, configured to set a contribution identifier corresponding to the blockchain node in the blockchain based on contributions of the blockchain node to the blockchain, where the contribution identifier is used for recording the degree of contributions of the blockchain node to the blockchain.

Optionally, the data sharing apparatus 1100 can further include: a first contribution value adjustment module, configured to increase, when a first blockchain node writes the accumulated data into the blockchain, a value of a contribution identifier corresponding to the first blockchain node by a first quantity value.

Optionally, the data sharing apparatus 1100 can further include: a second contribution value adjustment module, configured to increase, when the accumulated data written into the blockchain by a second blockchain node is read by other blockchain nodes, a value of a contribution identifier corresponding to the second blockchain node by a second quantity value.

Optionally, the data sharing apparatus 1100 can further include: a third contribution value adjustment module, configured to subtract, when a third blockchain node does not write the accumulated data into the blockchain within predetermined duration, a third quantity value from a value of a contribution identifier corresponding to the third blockchain node.

Optionally, the data sharing apparatus 1100 can further include: a penalty adjustment module, configured to adjust, when a fourth blockchain node makes a penalty decision on a penalized blockchain node, the penalty content of the penalty decision based on a value of a contribution identifier corresponding to the penalized blockchain node.

The embodiments of the present specification also provide an electronic device for data sharing, including: at least one processor; and a memory communicatively coupled to the at least one processor, where the memory stores instructions executable by the at least one processor, where the instructions are executed by the at least one processor such that the at least one processor is able to: determine, when receiving a transaction request initiated by a user, whether accumulated data corresponding to the user exists in a blockchain, where the accumulated data is industry experience data used for representing whether the transaction request of the user is a suspicious transaction; broadcast a data query request to a blockchain node in the blockchain when determining that the accumulated data does not exist in the blockchain, where the data query request includes user information of the user; receive transaction link data returned by the blockchain node in response to the data query request, where the transaction link data is link data of transaction data corresponding to the user information in the blockchain node; and mine the accumulated data corresponding to the user based on the transaction link data.

The embodiments of the present specification also provide a non-volatile computer storage medium for data sharing, storing computer executable instructions configured to: determine, when receiving a transaction request initiated by a user, whether accumulated data corresponding to the user exists in a blockchain, where the accumulated data is industry experience data used for representing whether the transaction request of the user is a suspicious transaction; broadcast a data query request to a blockchain node in the blockchain when determining that the accumulated data does not exist in the blockchain, where the data query request includes user information of the user; receive transaction link data returned by the blockchain node in response to the data query request, where the transaction link data is link data of transaction data corresponding to the user information in the blockchain node; and mine the accumulated data corresponding to the user based on the transaction link data.

Specific embodiments of the present specification have been described previously. Other embodiments fall within the scope of the appended claims. In some cases, the actions or steps described in the claims can be performed in a different order than embodiments and can still achieve desired results. In addition, the processes described in the drawings do not necessarily require a specific order or sequential order shown in order to achieve the desired results. In some implementations, multitasking and parallel processing are also possible or may be advantageous.

The various embodiments in the present specification are described progressively. For the same or similar parts of the various embodiments, references can be made to each other. The various embodiments place emphasis on differences from other embodiments. In particular, for the system, apparatus, device, and non-volatile computer storage medium embodiments, which correspond to the method, the description is relatively simple, and references can be made to the description of the method embodiments.

The system, apparatus, device, and non-volatile computer storage medium provided by the embodiments of the present specification correspond to the method, and also have similar advantageous technical effects to the corresponding method. Since the advantageous technical effects of the method have been described in detail previously, descriptions for the advantageous technical effects of the corresponding system, apparatus, device, and non-volatile computer storage medium are omitted here for simplicity.

In the 1990s, improvements to a technology could clearly distinguish between improvements in hardware (e.g., improvements to circuit structures such as diodes, transistors, and switches) and improvements in software (improvements to method flows). However, with the development of technologies, many current improvements in method process have been regarded as direct improvements in hardware circuit structure. Designers almost always obtain corresponding hardware circuit structures by programming the improved method process into hardware circuits. Therefore, it is incorrect that an improvement of a method process cannot be implemented with hardware entity modules. For example, a programmable logic device (PLD) such as a field programmable gate array (FPGA) is an integrated circuit with logic functions determined by a user programming the device. It is programmed by a designer to “integrate” a digital system onto a PLD without requiring a chip manufacturer to design and manufacture application specific integrated circuit (ASIC) chips. Moreover, nowadays, instead of manually manufacturing integrated circuit chips, such programming is mostly implemented by using “logic compiler” software, which is similar to a software compiler used at the time of program development and writing, and original code to be compiled must also be written in a specific programming language, which is referred to as a hardware description language (HDL). There are many HDLs rather than one HDL, such as an advanced boolean expression language (ABEL), an Altera hardware description language (AHDL), Confluence, a Cornell university programming language (CUPL), HDCal, a Java hardware description language (JHDL), Lava, Lola, MyHDL, PALASM, and a Ruby hardware description language (RHDL). A very-high-speed integrated circuit hardware description language (VHDL) and Verilog are most commonly used at present. It will also be apparent to those skilled in the art that a hardware circuit implementing the logic method process can be readily obtained by only slightly logically programming and programming the method process into an integrated circuit by using the previous several hardware description languages.

A controller can be implemented in any suitable way. For example, the controller can take the form of, for example, a micro-processor or processor and a computer readable medium storing computer readable program code (e.g., software or firmware) executable by the (micro) processor, logic gates, switches, ASICs, programmable logic controllers, and embedded micro controllers. Examples of the controller include, but are not limited to, the following micro controllers: ARC 625D, Atmel AT91SAM, Microchip PIC18F26K20, and Silicone Labs C8051F320. The memory controller can also be implemented as a part of the control logic of the memory. Those skilled in the art will also know that, in addition to implementing the controller in pure computer readable program code, it is entirely possible to logically program the method steps such that the controller implements the same function in the form of logic gates, switches, ASICs, programmable logic controllers, embedded micro controllers, etc. Such a controller may thus be regarded as a hardware component, and an apparatus that is included in the hardware component and configured to implement various functions can also be regarded as a structure within the hardware component. Or even, the apparatus for implementing various functions can be regarded as a software module implementing the method and a structure within the hardware component.

The system, apparatus, module, or unit illustrated in the previous embodiments can be specifically implemented by using a computer chip or an entity, or can be implemented by using a product having a certain function. A typical implementation device is a computer. Specifically, the computer can be, for example, a personal computer, a laptop computer, a cellular phone, a camera phone, a smartphone, a personal digital assistant, a media player, a navigation device, an email receiving and transmitting device, a game console, a tablet, a wearable device, or any combination of these devices.

For convenience of description, the previous apparatuses are described, respectively, as being functionally divided into various units. Of course, the functions of the various units can be implemented in one or more pieces of software and/or hardware when implementing the present application.

A person skilled in the art should understand that the embodiments of the present disclosure can be provided as methods, systems or computer program products. Therefore, the embodiments of the present disclosure can adopt forms of complete hardware embodiments, complete software embodiments or embodiments integrating software and hardware. Moreover, the present disclosure can adopt the form of a computer program product implemented on one or more computer usable storage media (including but not limited to a disk memory, a CD-ROM, an optical memory, etc.) containing computer usable program code.

The present disclosure is described with reference to flowcharts and/or block diagrams of the method, the device (system), and the computer program product according to the embodiments of the present disclosure. It should be understood that each process and/or block in the flowcharts and/or block diagrams and combinations of flows and/or blocks in the flowcharts and/or block diagrams can be implemented by computer program instructions. These computer program instructions can be provided to a general-purpose computer, a special-purpose computer, an embedded processor, or a processor of another programmable data processing device to generate a machine, such that instructions executed by the computer or the processor of the another programmable data processing device produce an apparatus for implementing functions specified in one or more flows in the flowcharts and/or one or more blocks in the block diagrams.

These computer program instructions can also be stored in a computer readable memory capable of guiding a computer or another programmable data processing device to work in a specific way, such that instructions stored in the computer readable memory produce a product including an instruction apparatus that implements functions specified in one or more flows in the flowcharts and/or one or more blocks in the block diagrams.

These computer program instructions can also be loaded to a computer or another programmable data processing device, such that a series of operating steps are performed on the computer or the other programmable data processing devices to produce a computer-implemented process, and therefore instructions executed on the computer or the other programmable data processing devices provide steps for implementing functions specified in one or more flows in the flowcharts and/or one or more blocks in the block diagrams.

In a typical configuration, the computer includes one or more central processing units (CPUs), an input/output interface, a network interface, and a memory.

The memory may include a non-persistent memory, a random access memory (RAM), and/or a non-volatile memory in a computer readable medium, such as a read-only memory (ROM) or a flash RAM. The memory is an example of the computer readable medium.

The computer readable medium includes persistent, non-persistent, movable, and unmovable media that can store information by using any method or technology. The information can be a computer readable instruction, a data structure, a program module, or other data. Examples of the computer storage medium include but are not limited to a phase change random access memory (PRAM), a static RAM (SRAM), a dynamic RAM (DRAM), a RAM of another type, a ROM, an electrically erasable programmable ROM (EEPROM), a flash memory or another memory technology, a compact disc ROM (CD-ROM), a digital versatile disc (DVD), or another optical storage, a cassette, a magnetic disk storage, or another magnetic storage device or any other non-transmission medium. The computer storage medium can be configured to store information that can be accessed by a computing device. As described in the present application, the computer readable medium does not include computer readable transitory media such as a modulated data signal and a carrier.

It is also worthwhile to note that the terms “include”, “contain” or any other variations thereof are intended to cover a non-exclusive inclusion, such that a process, method, product, or device including a series of elements includes not only those elements but also other elements not explicitly listed, or elements that are inherent to such process, method, product, or device. Without more restrictions, elements described by the phrase “include a/an . . . ” do not exclude the existence of additional identical elements in the process, method, product, or device that includes the elements.

The present application can be described in the general context of computer executable instructions, such as program modules, executed by a computer. Generally, the program modules include routines, programs, objects, components, data structures, etc. that perform particular tasks or implement particular abstract data types. The present application can also be practiced in distributed computing environments where tasks are performed by remote processing devices that are connected through a communications network. In the distributed computing environments, the program modules can be located in both local and remote computer storage media including storage devices.

The previous descriptions are merely embodiments of the present application, and are not intended to limit the present application. For those skilled in the art, there can be various changes and variations of the present application. Any modifications, equivalent substitutions, improvements, etc. that come within the spirit and principles of the present application are intended to be included within the scope of the claims of the present application.

What is claimed is:

1. A computer-implemented method, comprising:
responsive to a transaction request initiated by a user, determining whether accumulated data corresponding to the user is stored in a first blockchain node of a blockchain network, wherein the accumulated data indicates whether the transaction request comprises a suspicious transaction;
in response to determining that the accumulated data is not stored in the first blockchain node, broadcasting a data query request to a plurality of blockchain nodes of the blockchain network other than the first blockchain node, wherein the data query request comprises user information of the user;
receiving one or more pieces of transaction link data from the plurality of blockchain nodes of the blockchain network other than the first blockchain node, wherein each of the one or more pieces of transaction link data comprises link data of transaction data that corresponds to the user information and that is associated with one of the plurality of blockchain nodes of the blockchain network other than the first blockchain node;
retrieving, based at least on the one or more pieces of transaction link data and according to a predetermined rule, the accumulated data corresponding to the user; and
determining, based on retrieved accumulated data, whether the transaction request comprises a suspicious transaction.

2. The computer-implemented method of claim 1, wherein the link data of transaction data that is stored in one of the plurality of blockchain nodes of the blockchain network indicates a relationship between transaction data associated with the one of the plurality of blockchain nodes.

3. The computer-implemented method of claim 1, wherein determining whether the accumulated data corresponding to the user is stored in the first blockchain node of the blockchain network comprises:
determining, using a first smart contract, whether the accumulated data corresponding to the user is stored in the first blockchain node of the blockchain network.

4. The computer-implemented method of claim 1, wherein retrieving, based at least on the one or more pieces of transaction link data and according to the predetermined rule, the accumulated data corresponding to the user comprises:
retrieving, using a second smart contract, the accumulated data corresponding to the user based at least on the one or more pieces of transaction link data.

5. The computer-implemented method of claim 1, wherein the user information of the user comprises an identifier of the user; and
retrieving, based at least on the one or more pieces of transaction link data and according to the predetermined rule, the accumulated data corresponding to the user comprises:
obtaining the identifier of the user from the one or more pieces of transaction link data; and
retrieving the accumulated data corresponding to the user from the one or more pieces of transaction link data based on the identifier of the user.

6. The computer-implemented method of claim 1, further comprising:
generating block data based on the retrieved accumulated data, wherein the block data comprises a block header for storing an identifier of the block data, and a block body for storing the retrieved accumulated data; and
recording the block data to a blockchain stored in the blockchain network.

7. The computer-implemented method of claim 1, further comprising:
generating a contribution identifier corresponding to each blockchain node of the blockchain network, wherein the contribution identifier indicates a degree of contributions of the blockchain node to the blockchain network.

8. A non-transitory, computer-readable medium storing one or more instructions executable by a computer system to perform operations comprising:
responsive to a transaction request initiated by a user, determining whether accumulated data corresponding to the user is stored in a first blockchain node of a blockchain network, wherein the accumulated data indicates whether the transaction request comprises a suspicious transaction;
in response to determining that the accumulated data is not stored in the first blockchain node, broadcasting a data query request to a plurality of blockchain nodes of the blockchain network other than the first blockchain node, wherein the data query request comprises user information of the user;
receiving one or more pieces of transaction link data from the plurality of blockchain nodes of the blockchain network other than the first blockchain node, wherein each of the one or more pieces of transaction link data comprises link data of transaction data that corresponds to the user information and that is associated with one of the plurality of blockchain nodes of the blockchain network other than the first blockchain node;
retrieving, based at least on the one or more pieces of transaction link data and according to a predetermined rule, the accumulated data corresponding to the user; and
determining, based on retrieved accumulated data, whether the transaction request comprises a suspicious transaction.

9. The non-transitory, computer-readable medium of claim 8, wherein the link data of transaction data that is stored in one of the plurality of blockchain nodes of the blockchain network indicates a relationship between transaction data associated with the one of the plurality of blockchain nodes.

10. The non-transitory, computer-readable medium of claim 8, wherein determining whether the accumulated data corresponding to the user is stored in the first blockchain node of the blockchain network comprises:
determining, using a first smart contract, whether the accumulated data corresponding to the user is stored in the first blockchain node of the blockchain network.

11. The non-transitory, computer-readable medium of claim 8, wherein retrieving, based at least on the one or more pieces of transaction link data and according to the predetermined rule, the accumulated data corresponding to the user comprises:
retrieving, using a second smart contract, the accumulated data corresponding to the user based at least on the one or more pieces of transaction link data.

12. The non-transitory, computer-readable medium of claim 8, wherein the user information of the user comprises an identifier of the user; and
retrieving, based at least on the one or more pieces of transaction link data and according to the predetermined rule, the accumulated data corresponding to the user comprises:
obtaining the identifier of the user from the one or more pieces of transaction link data; and
retrieving the accumulated data corresponding to the user from the one or more pieces of transaction link data based on the identifier of the user.

13. The non-transitory, computer-readable medium of claim 8, wherein the operations further comprise:
generating block data based on the retrieved accumulated data, wherein the block data comprises a block header for storing an identifier of the block data, and a block body for storing the retrieved accumulated data; and
recording the block data to a blockchain stored in the blockchain network.

14. The non-transitory, computer-readable medium of claim 8, wherein the operations further comprise:
generating a contribution identifier corresponding to each blockchain node of the blockchain network, wherein the contribution identifier indicates a degree of contributions of the blockchain node to the blockchain network.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
responsive to a transaction request initiated by a user, determining whether accumulated data corresponding to the user is stored in a first blockchain node of a blockchain network, wherein the accumulated data indicates whether the transaction request comprises a suspicious transaction;
in response to determining that the accumulated data is not stored in the first blockchain node, broadcasting a data query request to a plurality of blockchain nodes of the blockchain network other than the first blockchain node, wherein the data query request comprises user information of the user;
receiving one or more pieces of transaction link data from the plurality of blockchain nodes of the blockchain network other than the first blockchain node, wherein each of the one or more pieces of transaction link data comprises link data of transaction data that corresponds to the user information and that is associated with one of the plurality of blockchain nodes of the blockchain network other than the first blockchain node;
retrieving, based at least on the one or more pieces of transaction link data and according to a predetermined rule, the accumulated data corresponding to the user; and
determining, based on retrieved accumulated data, whether the transaction request comprises a suspicious transaction.

16. The computer-implemented system of claim 15, wherein the link data of transaction data that is stored in one of the plurality of blockchain nodes of the blockchain network indicates a relationship between transaction data associated with the one of the plurality of blockchain nodes.

17. The computer-implemented system of claim 15, wherein determining whether the accumulated data corresponding to the user is stored in the first blockchain node of the blockchain network comprises:
determining, using a first smart contract, whether the accumulated data corresponding to the user is stored in the first blockchain node of the blockchain network.

18. The computer-implemented system of claim 15, wherein retrieving, based at least on the one or more pieces of transaction link data and according to the predetermined rule, the accumulated data corresponding to the user comprises:
retrieving, using a second smart contract, the accumulated data corresponding to the user based at least on the one or more pieces of transaction link data.

19. The computer-implemented system of claim 15, wherein the user information of the user comprises an identifier of the user; and
retrieving, based at least on the one or more pieces of transaction link data and according to the predetermined rule, the accumulated data corresponding to the user comprises:
obtaining the identifier of the user from the one or more pieces of transaction link data; and
retrieving the accumulated data corresponding to the user from the one or more pieces of transaction link data based on the identifier of the user.

20. The computer-implemented system of claim 15, wherein the one or more operations further comprise:
generating block data based on the retrieved accumulated data, wherein the block data comprises a block header for storing an identifier of the block data, and a block body for storing the retrieved accumulated data; and
recording the block data to a blockchain stored in the blockchain network.
